(19) United States
(12) Patent Application Publication
(10) Pub. No.: US 2025/0157325 A1
(43) Pub. Date: May 15, 2025

(54) SYSTEMS AND METHODS FOR ENCOURAGING PEDESTRIAN GROUP MOVEMENT

(71) Applicant: Toyota Motor Engineering & Manufacturing North America, Inc., Plano, TX (US)

(72) Inventors: Benjamin Piya Austin, Saline, MI (US); Rohit Gupta, Santa Clara, CA (US); William Patrick Garrett, Plymouth, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/509,903

(22) Filed: Nov. 15, 2023

(51) Int. Cl. G08G 1/005

(52) U.S. Cl. CPC G08G 1/005

(57) ABSTRACT

Systems, methods, and other embodiments described herein relate to encouraging pedestrian group movement to enhance traffic flow. In one embodiment, a method includes identifying, based on sensor data, a movement behavior of a pedestrian. The method also includes classifying the pedestrian as being isolated from a group of pedestrians based on the movement behavior of the pedestrian and movement behavior of the group. The method also includes producing a group restoration countermeasure responsive to the pedestrian being classified as isolated from the group. The group restoration countermeasure encourages the pedestrian to join the group.

### TECHNICAL FIELD

The subject matter described herein relates, in general, to encouraging the efficient flow of pedestrian traffic and, more particularly, to encouraging a pedestrian who is isolated from or trailing behind a group of pedestrians to join the group to enhance pedestrian traffic flow.

### BACKGROUND

Vehicle roadways and the adjacent infrastructure are becoming increasingly complex and populated with motorists and pedestrians. This is perhaps most apparent in urban areas with significant population and vehicle densities. As both vehicles and pedestrians are near one another based on their respective utilization of roadways and adjacent infrastructure elements (e.g., sidewalks) and the occasional occupation of the roadways by pedestrians (such as at crosswalks), vehicle-pedestrian interactions are inevitable and a regular occurrence. For example, a pedestrian may desire to cross a road to reach an intended destination. Pedestrians generally use crosswalks to traverse the road to reach their destination safely.

### SUMMARY

In one embodiment, example systems and methods relate to a manner of improving pedestrian traffic flow, in particular when crossing a roadway.

In one embodiment, a group restoration system for enhancing pedestrian traffic flow via group restoration countermeasures such as visual/audible notifications and user device alterations is disclosed. The group restoration system includes one or more processors and a memory communicably coupled to the one or more processors. The memory stores instructions that, when executed by the one or more processors, cause the one or more processors to identify, based on sensor data, the movement behavior of a pedestrian and classify the pedestrian as being isolated from a group of pedestrians based on the movement behavior of the pedestrian and movement behavior of the group. The memory also stores instructions that, when executed by the one or more processors, cause the one or more processors to produce a group restoration countermeasure responsive to the pedestrian being classified as isolated from the group. The group restoration countermeasure encourages the pedestrian to join the group.

In one embodiment, a non-transitory computer-readable medium for enhancing pedestrian traffic flow and including instructions that, when executed by one or more processors, cause the one or more processors to perform one or more functions is disclosed. The instructions include instructions to identify, based on sensor data, movement behavior of a pedestrian. The instructions include instructions to classify the pedestrian as being isolated from a group of pedestrians based on the movement behavior of the pedestrian and movement behavior of the group. The instructions include instructions to produce a group restoration countermeasure responsive to the pedestrian being classified as isolated from the group. The group restoration countermeasure encourages the pedestrian to join the group.

In one embodiment, a method for improving pedestrian traffic, especially across a roadway is disclosed. In one embodiment, the method includes identifying, based on sensor data, movement behavior of a pedestrian. The method also includes classifying the pedestrian as being isolated from a group of pedestrians based on the movement behavior of the pedestrian and movement behavior of the group. The method also includes producing a group restoration countermeasure responsive to the pedestrian being classified as isolated from the group. The group restoration countermeasure encourages the pedestrian to join the group.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of a group restoration system that is associated with encouraging pedestrian group movement.

FIGS. 3A-3C illustrate a group restoration system encouraging a lone pedestrian to rejoin a group of pedestrians.

FIG. 4 illustrates a flowchart for one embodiment of a method that is associated with encouraging a lone pedestrian to rejoin a group of pedestrians.

FIG. 5 illustrates one embodiment of a group restoration system that is associated with encouraging pedestrian group movement.

FIG. 6 illustrates one embodiment of a group restoration system that is associated with encouraging pedestrian group movement.

### DETAILED DESCRIPTION

Systems, methods, and other embodiments associated with improving pedestrian and vehicle traffic flow are disclosed herein. As described above, vehicle roadways are complex and occupied by both pedestrians and vehicles, in some cases simultaneously. For example, a vehicle may want to turn right onto a roadway that pedestrians are actively traversing. While the co-presence of vehicles and pedestrians on roadways may have some inherent dangers, these and other mixed-use situations may be navigated safely. For example, pedestrian crossing signals and traffic lights may facilitate the safe and efficient movement of pedestrians across a roadway and vehicles along the roadway.

However, some pedestrian behaviors may increase the risk of a dangerous pedestrian-vehicle interaction. Even if a behavior does not increase the risk of a dangerous interaction, a behavior may negatively impact vehicle and/or pedestrian traffic flow. For example, a group of pedestrians may be crossing a roadway following the indication from a pedestrian crossing signal that it is safe to cross. In this scenario, a vehicle attempting to turn onto the roadway waits until the group passes. However, if a pedestrian is straggling or trailing behind the group, the vehicle must wait an extended period for that straggling pedestrian to cross. Thus, while the vehicle appropriately waits for the trailing pedestrian to cross, the behavior of the trailing pedestrian may lead to vehicle traffic congestion and/or other dangerous circumstances, such as a blocked intersection while the vehicle waits for the straggling pedestrian to traverse the crosswalk. However, the traffic flow and overall safety of pedestrians (including the trailing pedestrian) may be improved if the pedestrian instead crosses the road with the rest of the group. As such, the present system improves traffic flow by encouraging pedestrians to walk with a group of pedestrians to decrease the time it takes the pedestrians to cross a roadway.

In an example, the group restoration system accesses cameras where pedestrians are located to identify pedestrians that are lagging or trailing behind a group or otherwise deviating from the herd mentality of a group of pedestrians. When a deviating pedestrian is identified, the group restoration system encourages that pedestrian to walk with the group.

In one approach, the group restoration system encourages the pedestrian via a pedestrian-directed notification. In one example, the group restoration system communicates with a nearby vehicle or infrastructure element to group the pedestrians via audible and visual notifications. For example, the vehicle or infrastructure element may include lights that show pedestrians which direction to move. In another example, sounds and lights can direct pedestrians away from the road towards the crosswalk.

The group restoration system can encourage pedestrian behavior in other ways as well. For example, if the pedestrian is listening to music on a user device, the group restoration system may cut off the music if the pedestrian falls behind the group. As another example, the group restoration system may temporarily interrupt the connectivity of the user device of the pedestrian. In either case, user device operability may be restored when the pedestrian catches up to the group.

In other examples, rather than reducing the operational capability of a user device, the group restoration system may enhance the operational capacity of the user device based on the proximity of the pedestrian to the group. For example, the group restoration countermeasure may control the wireless data bandwidth of the user device such that the best/most robust signal/data is found at the center of the group of pedestrians.

In addition to these demerits for being away from the group, the group restoration system may reward the pedestrian for staying with the group. For example, a pedestrian may accumulate 1) credits that could be used for free rides on public transportation or 2) electric vehicle charging credits when the pedestrian travels with or near the group of pedestrians.

In this way, the disclosed systems, methods, and other embodiments provide new ways of improving vehicle and pedestrian traffic flow by generating messages to a trailing pedestrian and/or altering the operation of a pedestrian user device based on the distance between the pedestrian and the group. The present systems, methods, and other embodiments also enhance 1) vehicle perception of an environment by classifying a pedestrian as trailing behind a group of pedestrians and 2) vehicle and pedestrian safety by generating outputs that prompt pedestrians to re-engage with a group of pedestrians. The present system also reduces vehicle emissions by reducing the time a vehicle is idle waiting for a straggling pedestrian to cross a roadway.

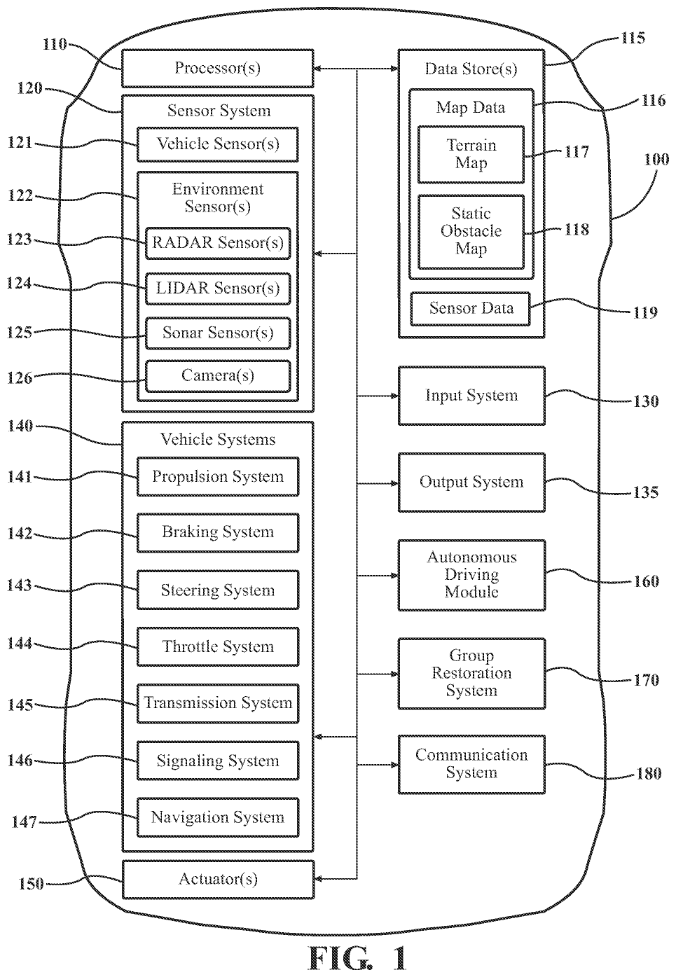

Referring to FIG. 1, an example of a vehicle 100 is illustrated. As used herein, a “vehicle” is any form of transport that may be motorized or otherwise powered. In one or more implementations, the vehicle 100 is an automobile. While arrangements will be described herein with respect to automobiles, it will be understood that embodiments are not limited to automobiles. In some implementations, the vehicle 100 may be a robotic device or a form of transport that, for example, includes sensors to perceive aspects of the surrounding environment, and thus benefits from the functionality discussed herein associated with encouraging a pedestrian to travel with a group of pedestrians, in particular across a crosswalk to reduce the traffic slowdowns, delays, and other inefficiencies that may result from the pedestrian straggling behind a group of pedestrians.

The vehicle 100 also includes various elements. It will be understood that in various embodiments it may not be necessary for the vehicle 100 to have all of the elements shown in FIG. 1. The vehicle 100 can have different combinations of the various elements shown in FIG. 1. Further, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Further, the elements shown may be physically separated by large distances. For example, as discussed, one or more components of the disclosed system can be implemented within a vehicle 100, while further components of the system are implemented within a cloud-computing environment or other system that is remote from the vehicle 100.

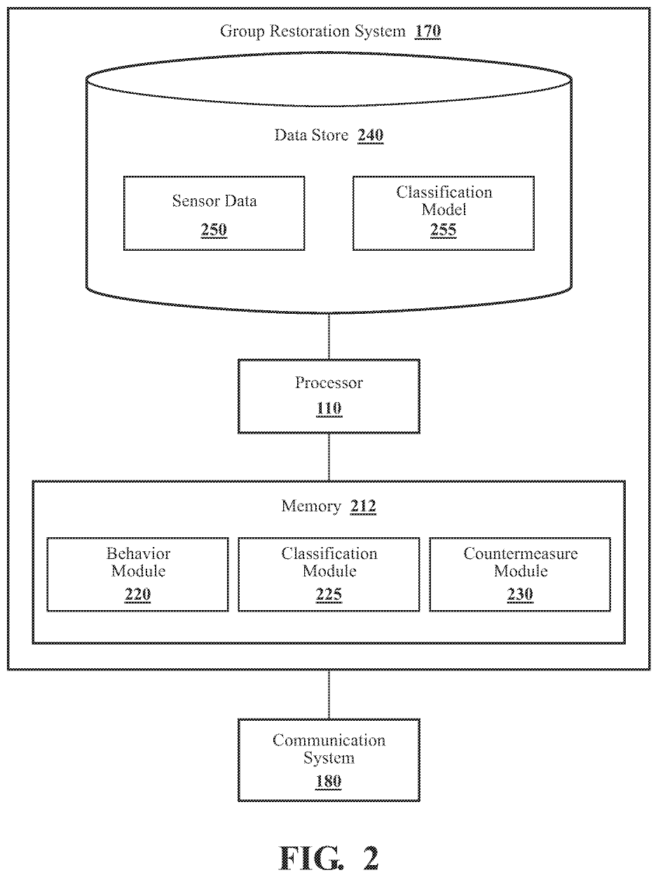

Some of the possible elements of the vehicle 100 are shown in FIG. 1 and will be described along with subsequent figures. However, a description of many of the elements in FIG. 1 will be provided after the discussion of FIGS. 2-6 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In any case, the vehicle 100 includes a group restoration system 170 that is implemented to perform methods and other functions as disclosed herein relating to improving pedestrian traffic flow, vehicle traffic flow, and pedestrian/motorist safety.

As will be discussed in greater detail subsequently, the group restoration system 170, in various embodiments, is implemented partially within the vehicle 100, and as a cloud-based service. For example, in one approach, functionality associated with at least one module of the group restoration system 170 is implemented within the vehicle 100 while further functionality is implemented within a cloud-based computing system. Thus, the group restoration system 170 may include a local instance at the vehicle 100 and a remote instance that functions within the cloud-based environment. The cloud-based environment itself is a dynamic environment that comprises cloud members who are routinely migrating into and out of a geographic area. In general, the geographic area, as discussed herein, is associated with a broad area, such as a city and surrounding suburbs. In any case, the area associated with the cloud environment can vary according to a particular implementation but generally extends across a wide geographic area.

Moreover, the group restoration system 170, as provided for within the vehicle 100, functions in cooperation with a communication system 180. In one embodiment, the communication system 180 communicates according to one or more communication standards. For example, the communication system 180 can include multiple different antennas/transceivers and/or other hardware elements for communicating at different frequencies and according to respective protocols. The communication system 180, in one arrangement, communicates via a communication protocol, such as a WiFi, dedicated short range communications (DSRC), vehicle-to-infrastructure (V2I), vehicle-to-vehicle (V2V), vehicle-to-pedestrian (V2P) or another suitable protocol for communicating between the vehicle 100 and other entities in the cloud environment. Moreover, the communication system 180, in one arrangement, further communicates according to a protocol, such as global system for mobile communication (GSM), Enhanced Data Rates for GSM Evolution (EDGE), Long-Term Evolution (LTE), 5G, or another communication technology that provides for the vehicle 100 communicating with various remote devices (e.g., a cloud-based server). In any case, the group restoration system 170 can leverage various wireless communication technologies to provide communications to other entities, such as members of the cloud-computing environment.

With reference to FIG. 2, one embodiment of the group restoration system 170 of FIG. 1 is further illustrated. The group restoration system 170 is shown as including a processor 110 from the vehicle 100 of FIG. 1. Accordingly, the processor 110 may be a part of the group restoration system 170, the group restoration system 170 may include a separate processor from the processor 110 of the vehicle 100, or the group restoration system 170 may access the processor 110 through a data bus or another communication path that is separate from the vehicle 100. In one embodiment, the group restoration system 170 includes a memory 212 that stores a behavior module 220, a classification module 225, and a countermeasure module 230. The memory 212 is a random-access memory (RAM), read-only memory (ROM), a hard-disk drive, a flash memory, or another suitable memory for storing the modules 220, 225, and 230. The modules 220, 225, and 230 are, for example, computer-readable instructions that when executed by the processor 110 cause the processor 110 to perform the various functions disclosed herein. In alternative arrangements, the modules 220, 225, and 230 are independent elements from the memory 212 that are, for example, comprised of hardware elements. Thus, the modules 220, 225, and 230 are alternatively application-specific integrated circuits (ASICs), hardware-based controllers, a composition of logic gates, or another hardware-based solution.

Moreover, in one embodiment, the group restoration system 170 includes the data store 240. The data store 240 is, in one embodiment, an electronic data structure stored in the memory 212 or another data storage device and that is configured with routines that can be executed by the processor 110 for analyzing stored data, providing stored data, organizing stored data, and so on. Thus, in one embodiment, the data store 240 stores data used by the modules 220, 225, and 230 in executing various functions. In one embodiment, the data store 240 stores the sensor data 250 along with, for example, metadata that characterizes various aspects of the sensor data 250. For example, the metadata can include location coordinates (e.g., longitude and latitude), relative map coordinates or tile identifiers, time/date stamps from when the separate sensor data 250 was generated, and so on. In an example, the sensor data 250 is an example of the sensor data 119 described in FIG. 1. That is, the sensor data 250 may include observations of the surrounding environment of the vehicle 100 and/or information about the vehicle 100 itself.

In general, the group restoration system 170 identifies when a pedestrian is straggling, trailing, or otherwise isolated behind a group of pedestrians. The sensor data 250 includes data from which such a determination is made. Specifically, the sensor data 250 includes at least camera images that depict the environment surrounding the vehicle 100 and of pedestrians and groups of pedestrians within the environment. In further arrangements, the sensor data 250 includes the output of other sensors such as a radar sensor 123, a LiDAR sensor 124, and other sensors as may be suitable for identifying pedestrians and the location/movement of pedestrians.

In some examples, the sensor data 250 may be from vehicle-mounted sensors. That is, the vehicle 100 may include sensors such as a camera 126, a sonar sensor 125, a LiDAR sensor 124, and/or a radar sensor 123 that can capture images or otherwise perceive pedestrians in the vicinity of the vehicle 100.

In some examples, the sensor data 250 may be from infrastructure-mounted sensors. That is, infrastructure elements such as traffic lights and lamp posts, among others, may include cameras, sonar sensors, LiDAR sensors, and/or radar sensors that similarly record the environment of the vehicle 100, including the pedestrians therein. In this example, the infrastructure-mounted environment sensor output (e.g., camera images, LiDAR output, radar output, and sonar output) may be received at the group restoration system 170 via the communication system 180. In this example, the communication system 180 may communicate via a V2I or V2V communication framework. A V2V or V2I communication framework is a wireless bi-directional communication path wherein data is shared between vehicles and/or infrastructure elements via an ad hoc network. In this network, different entities may be added via a handshake process when they come within a threshold distance of one another. The V2V or V2I network transfers data with DSRC frequencies. As such, both the vehicle 100 and the infrastructure element include antennas/transceivers and other hardware components to facilitate the transfer of images, or other sensor output, from the infrastructure element and/or other vehicles to the vehicle 100 for identification of a straggling pedestrian and generation of an appropriate countermeasure.

In an example, the sensor data 250 may include non-image-based location information for the pedestrian(s). For example, some user devices are equipped with GPS that record the coordinate-based location of the pedestrian. In this example, the sensor data 250 may include the coordinates collected from user devices in the V2P, V2V, V2I, or vehicle-to-everything (V2X) communication network via the communication system 180.

In one embodiment, the data store 240 further includes a classification model 255, which may be relied on by the classification module 225 to classify the pedestrian as straggling or isolated/trailing from the group of pedestrians. In some examples, the group restoration system 170 is a machine learning system. A machine-learning system generally identifies patterns and/or deviations based on previously unseen data. In the context of the present application, a machine-learning group restoration system 170 relies on some form of machine learning, whether supervised, unsupervised, reinforcement, or any other type of machine learning, to infer whether the pedestrian is straggling behind a group and thus should be prompted to join the group, or whether the pedestrian is engaging in some behavior that should not trigger group restoration. For example, a pedestrian may remain at the intersection on a phone call without intending to cross the road while the rest of the group advances across the crosswalk. In another example, a pedestrian may be waiting to cross one roadway of the intersection while the group crosses another roadway of the intersection. In this example, the classification module 225 may be a machine learning system that can differentiate pedestrians unaffiliated with the group (and thus not straggling) from those pedestrians associated with a group and straggling behind the group.

In an example, the classification model 255 is a supervised model where the machine learning is trained with an input data set and optimized to meet a set of specific outputs. In another example, the classification model 255 is an unsupervised model where the model is trained with an input data set but not optimized to meet a set of specific outputs; instead, it is trained to classify based on common characteristics. As another example, the classification model 255 may be a self-trained reinforcement model based on trial and error.

In any case, the classification model 255 includes the weights (including trainable and non-trainable), biases, variables, offset values, algorithms, parameters, and other elements that operate to output a pedestrian classification based on any number of input values, including sensor data 250. Examples of machine-learning models include, but are not limited to, logistic regression models, Support Vector Machine (SVM) models, naïve Bayes models, decision tree models, linear regression models, k-nearest neighbor models, random forest models, boosting algorithm models, and hierarchical clustering models. While particular models are described herein, the classification model 255 may be of various types intended to classify pedestrians based on determined movement behaviors.

The group restoration system 170 further includes a behavior module 220 which, in one embodiment, includes instructions that cause the processor 110 to identify, based on sensor data 250, the movement behavior of a pedestrian. The movement of the pedestrian may determine whether the pedestrian is lagging behind a group, is walking with the group, or is separate and unaffiliated with the group. The behavior module 220 may include instructions that cause the processor 110 to detect/recognize objects in the images or other sensor data and then track the objects over different video stream frames to determine to which category (e.g., lagging behind a group, walking with the group, or unaffiliated with the group) a particular pedestrian pertains.

Accordingly, the behavior module 220, in one embodiment, controls the respective sensors to provide the data inputs in the form of the sensor data 250. Additionally, while the behavior module 220 is discussed as controlling the various sensors to provide the sensor data 250, in one or more embodiments, the behavior module 220 can employ other techniques to acquire the sensor data 250 that are either active or passive. For example, the behavior module 220 may passively sniff the sensor data 250 from a stream of electronic information provided by the various sensors to further components within the vehicle 100. Moreover, the behavior module 220 can undertake various approaches to fuse data from multiple sensors when providing the sensor data 250 and/or from sensor data acquired over a wireless communication link (e.g., V2V or V2I) from one or more of the surrounding vehicles and infrastructure elements. Thus, the sensor data 250, in one embodiment, represents a combination of perceptions acquired from multiple sensors.

Moreover, the behavior module 220, in one embodiment, controls the sensors to acquire the sensor data 250 about an area that encompasses 360 degrees about the vehicle 100 in order to provide a comprehensive assessment of the surrounding environment. Of course, in alternative embodiments, the behavior module 220 may acquire the sensor data about a forward direction alone when, for example, the vehicle 100 is not equipped with further sensors to include additional regions about the vehicle and/or the additional regions are not scanned due to other reasons (e.g., unnecessary due to known current conditions).

In an example, the behavior module 220 includes a computer vision system that tracks the movement of the pedestrian and the group of pedestrians across video stream frames. As such, the behavior module 220 may include an image processor that identifies individual pedestrians in a captured image and identifies clusters of pedestrians as groups. As such, the behavior module 220 may include a clustering instruction that causes the processor 110 to identify a group of pedestrians. In an example, clusters of pedestrians may be grouped based on the relative distance between pedestrians. That is, the behavior module 220 not only detects objects in an image but may also determine the positional information of the detected objects and use the positional information to define groups of pedestrians. In a specific example, the behavior module 220 clusters pedestrians within a threshold distance of one another into a group. For example, pedestrians that are less than 0.5 meters away from one another may form part of a group. By comparison, a pedestrian more than 0.5 meters away from another pedestrian or an already-defined group may be determined as separate from the group. While particular reference is made to one metric by which a pedestrian group is defined, other metrics may be implemented, such as the threshold distance being based on the number of pedestrians in the group. For example, the larger the group, the greater the threshold distance by which group membership is determined. As another example, a pedestrian may be determined to be a part of a group based on the distance of the pedestrian from the center of the group.

To track the pedestrian and group of pedestrians, the behavior module 220 may perform multiple object tracking (MOT) where the individual pedestrians and a cluster of pedestrians identified as a group are separate objects to be tracked. Each tracked object (e.g., individual pedestrians and groups of pedestrians) is identified in a first frame, labeled, and tracked through various frames of captured images. While one example of object tracking is described, other modalities for tracking the pedestrian and group of pedestrians may be implemented in accordance with the principles described herein.

As 1) the behavior module 220 analyzes image data, or other sensor output, to track objects through frames of a video and 2) the images may originate from infrastructure elements or vehicle-mounted environment sensors, the behavior module 220 may include instructions that cause the processor 110 to identify movement behavior based on sensor data 250 collected from at least one of an infrastructure environment sensor or a vehicle environment sensor.

During object tracking, the behavior module 220 may record the location of the pedestrian and the location of the group of pedestrians. That is to say, in an example, the behavior module 220 includes instructions that cause the processor 110 to identify the location of the pedestrian. As described below, the classification module 225 may rely on the location of the pedestrian and the group of pedestrians to determine whether the pedestrian is straggling behind the group.

In an example, the behavior module 220 includes instructions that cause the processor 110 to identify the direction of travel of the pedestrian and the velocity of the pedestrian as well as the direction of travel of the group of pedestrians and the velocity of the group of pedestrians. That is, during object tracking, the behavior module 220 can determine the direction and speed of travel of the pedestrian and group of pedestrians by comparing the relative position of the pedestrian and group of pedestrians in adjacent video stream frames. As described below, the classification module 225 may rely on the direction and speed of travel of the pedestrian and group to classify the pedestrian as straggling, trailing, or otherwise isolated from the group.

In an example, object tracking may be done in real-time, for example, as a camera 126 captures images of pedestrians crossing a roadway. In an example, the behavior module 220 may be a machine learning module that relies on deep learning or another algorithm to detect and track objects through video frames. In the context of the present application, a behavior module 220 relies on machine learning, whether supervised, unsupervised, reinforcement, or any other type, to detect, label, and track objects through a sequence of video frames.

The group restoration system 170 further includes a classification module 225 which, in one embodiment, includes instructions that cause the processor 110 to classify the pedestrian as being isolated from a group of pedestrians based on the movement behavior of the pedestrian and movement behavior of the group of pedestrians. As described above, pedestrians moving in the same direction as a group of pedestrians but behind or in front of the group may adversely affect the efficient travel of vehicles and/or pedestrians. Examples of adverse effects that result from non-group pedestrian travel include blocked intersections and congested traffic. As such, the classification module 225 classifies when a pedestrian may be straggling or lagging behind the group such that an appropriate group restoration countermeasure may be generated to prompt the pedestrian to rejoin or join the group.

As the classification is based on the movement behavior of the pedestrian and the movement behavior of a group of pedestrians, the classification module 225 is communicatively coupled to the behavior module 220. That is, the classification module 225 receives an output of the behavior module 220.

In an example, the classification of the pedestrian as straggling, isolated, or otherwise removed from the group may be based on the location information of the pedestrian and the location information of the group of pedestrians as determined by the behavior module 220. That is, the classification module 225 may include instructions that cause the processor 110 to classify the pedestrian as being isolated from the group when the location of the pedestrian is a threshold distance away from the location of the group.

The threshold against which the location difference of the pedestrian and group are compared may take a variety of forms. As a specific example, the behavior module 220 may determine a dimension (e.g., a width) of the group and classify the pedestrian as being isolated from the group based on the distance between the pedestrian and the group compared to the width of the group. For example, a pedestrian greater than two standard deviations away from the group may be defined as isolated from the group. In another example, membership in a group may be defined by a threshold that is independent of the size of the group. For example, a first pedestrian may be one meter from a group, while a second pedestrian may be seven meters away. Given a threshold of three meters, the first pedestrian may be determined to be associated with the group member, while the second pedestrian is deemed unaffiliated with the group because of the greater distance between the second pedestrian and the group. Note that while particular reference is made to a particular threshold, other threshold values may be implemented, which may be user-defined or selected by a vehicle original equipment manufacturer (OEM). While particular reference is made to particular location thresholds against which a straggling pedestrian is defined, other thresholds may be implemented in accordance with the principles described herein.

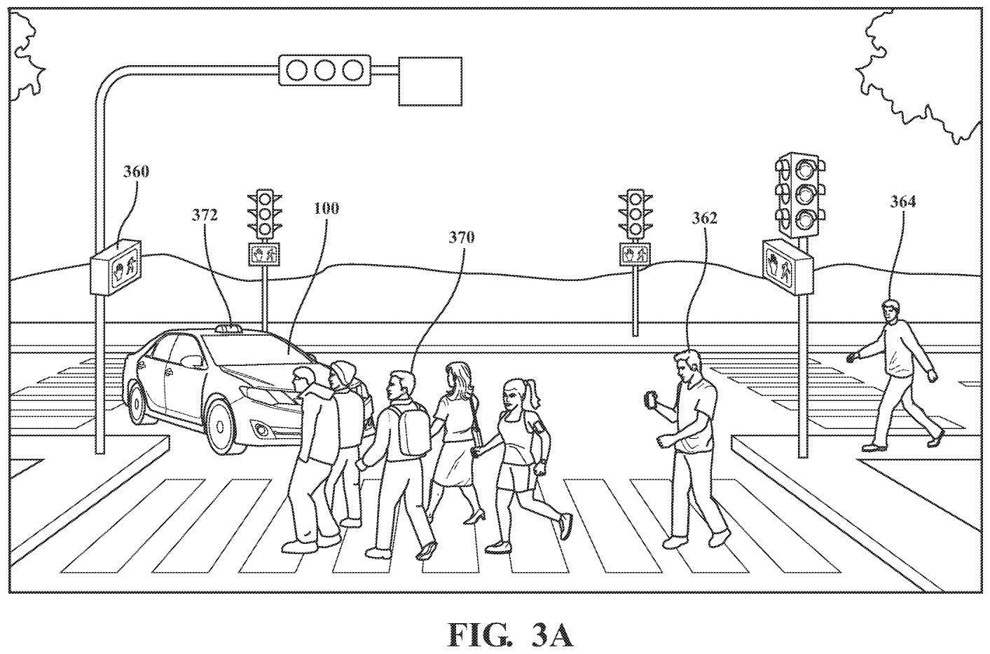

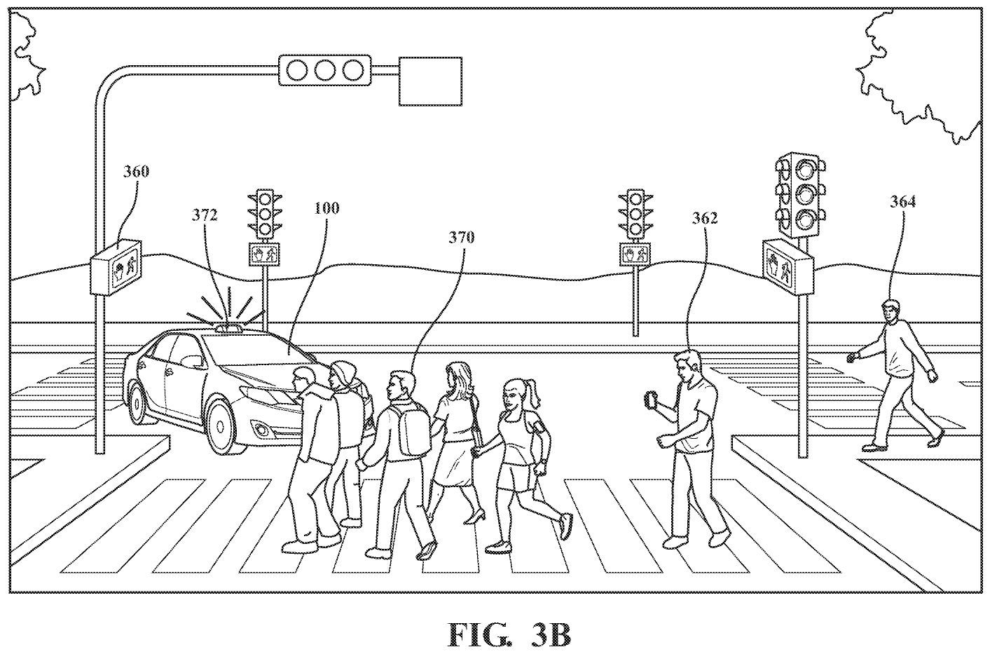

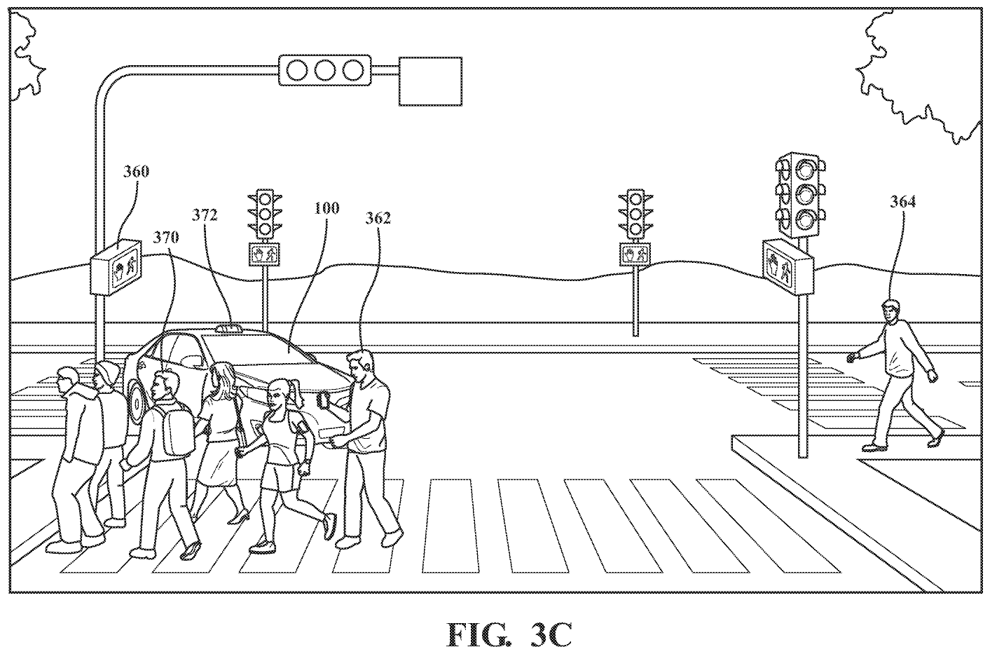

In another example, pedestrian classification may be based on additional data. For example, based on a comparison of a single movement data point (e.g., the location of the pedestrian compared to the location of the group of pedestrians), a pedestrian not affiliated with the group may be deemed straggling, isolated, or otherwise removed from the group and be incorrectly identified as a target of a group restoration countermeasure. For example, a group of pedestrians and a first and second pedestrian may be standing at a road intersection, with the group and first pedestrian intending to head in a first direction and the second pedestrian intending to head in a second direction (as depicted in FIG. 3A). When a crosswalk signal indicates the pedestrians walking in the first direction (i.e., the group of pedestrians and the first pedestrian) have the right-of-way, the group may start to move, the first pedestrian may remain (and therefore be lagging), and the second pedestrian may remain due to a lack of an indication of a second direction right-of-way. In this example, the location information of the first and second pedestrians may be sufficiently different from the group that each may be deemed a lagging pedestrian. This may be erroneous in the case of the second pedestrian and thus result in a false identification of a lagging pedestrian.

As such, in this example, the behavior module 220 may extract additional movement behavior information, such as the direction of travel of the pedestrians and the group and the velocity of the pedestrians and the group of pedestrians to classify the pedestrian as lagging, isolated, or trailing the group. In this example, the classification module 225 includes instructions that cause the processor 110 to classify the pedestrian as isolated from the group based on the additional information.

Turning to the example provided above, the behavior module 220 may determine 1) the direction of travel of the group to be in a northward direction at a rate of one mile per hour (mph), 2) the direction of travel of the first pedestrian to be in a northward direction at a rate of 0.5 mph, and 3) the direction of travel of the second pedestrian to be in an eastward direction at a rate of 0 mph (on account of the second pedestrian waiting an indication from a crosswalk traffic signal). In this example, on account of the group of pedestrians and the first pedestrian moving in the same direction (or within a threshold heading of one another) and the first pedestrian speed being less than that of the group of pedestrians (or greater than a threshold difference than that of the group of pedestrians), the classification module 225 may classify the first pedestrian as lagging or trailing behind the group. By comparison, on at least account of the second pedestrian direction of travel being different than that of the group, the classification module 225 may classify the second pedestrian as unaffiliated with the group and, therefore, not a pedestrian for whom a countermeasure should be generated. Note that threshold heading and speed differences implemented by the classification module 225 may vary. Examples of threshold heading differences include 10 degrees, 20 degrees, 30 degrees, 40 degrees, or any other threshold heading difference. In this case, a heading of a pedestrian that is different than the heading of the group by greater than the threshold amount would be deemed unaffiliated with the group. Examples of threshold speed differences include 5-10%, 10-20%, 20-30%, 30-40% or any other speed difference threshold. In this case, the speed of the pedestrian that is different than the speed of the group by greater than the threshold amount would be deemed as isolated, trailing, or removed from the group.

The above examples rely on image-based location information. In other examples, the classification may be based on non-image-based indications of location, direction, and/or speed. For example, as described above, user devices may include GPS or other location-based systems that transmit the location of the device to the group restoration system 170. In this example, similar to when image-based location information is relied on, the classification module 225 may compare the location, direction of travel, and/or speed of travel of the pedestrian with an identified group to determine whether the pedestrian is lagging or is unaffiliated with the group (i.e., not moving, traveling in a different direction, etc.).

In an example, the classification depends on a deviation of sensor data 250 from baseline data, which indicates baseline movement behaviors. In this example, the classification module 225 may include instructions that cause the processor 110 to compare the movement behavior of the pedestrian to baseline movement behavior, wherein the baseline movement behavior is indicative of a pattern of behavior of pedestrians when straggling, isolated, or otherwise trailing a group. In general, the baseline movement data generally reflects the historical patterns of those for whom it is collected and may be predictive of lagging. That is, there may be specific movement behaviors that indicate lagging pedestrians and other movement behaviors that indicate that the pedestrian is not lagging behind a group. As such, the baseline movement behavior may be tagged with metadata associating the baseline movement behavior with the lagging behaviors of the associated pedestrians. In an example, the classification module 225, which may be a machine-learning module, identifies patterns indicative of lagging and determines when the current behavior of the pedestrian aligns with those patterns. The alignment and degree of alignment of the current movement behaviors with the baseline data are relied on in determining whether the pedestrian is lagging or is spatially separated from the group for another reason.

As such, in this example the classification module 225 may compare the sensor data 250 tracking the position and movement of the pedestrian against baseline data that indicates patterns of behaviors indicative of lagging pedestrians (or unaffiliated pedestrians) to determine whether or not the pedestrian is lagging the group or is unaffiliated with the group. By comparing current sensor data 250 against baseline data, the classification module 225 can determine whether the pedestrian is lagging.

In one approach, the classification module 225 implements and/or otherwise uses a machine learning algorithm. A machine-learning algorithm generally identifies patterns and deviations based on previously unseen data. In the context of the present application, a machine-learning classification module 225 relies on some form of machine learning, whether supervised, unsupervised, reinforcement, or any other type of machine learning, to identify patterns in expected pedestrian behavior and infers whether a particular pedestrian is lagging behind a group and should be encouraged to join the group based on 1) the currently collected sensor data 250 and 2) a comparison of the currently collected sensor data 250 to historical patterns for pedestrians.

In one configuration, the machine learning algorithm is embedded within the classification module 225, such as a convolutional neural network (CNN) or an artificial neural network (ANN) to perform pedestrian classification over the sensor data 250, from which further information is derived. Of course, in further aspects, the classification module 225 may employ different machine learning algorithms or implement different approaches for performing the pedestrian lagging classification, which can include logistic regression, a naïve Bayes algorithm, a decision tree, a linear regression algorithm, a k-nearest neighbor algorithm, a random forest algorithm, a boosting algorithm, and a hierarchical clustering algorithm among others to generate pedestrian classifications. Other examples of machine learning algorithms include but are not limited to deep neural networks (DNN), including transformer networks, convolutional neural networks, recurrent neural networks (RNN), Support Vector Machines (SVM), clustering algorithms, Hidden Markov Models, and so on. It should be appreciated that the separate forms of machine learning algorithms may have distinct applications, such as agent modeling, machine perception, and so on.

Whichever particular approach the classification module 225 implements, the classification module 225 improves pedestrian classification by introducing machine-learning processing of hundreds, thousands, or millions of pieces of data. For example, the classification module 225 may receive information from hundreds, thousands, or tens of thousands of individuals with multiple behaviors that may or may not indicate a lagging behavior. This complex data, which would be impossible to process otherwise, is processed through machine learning to identify patterns against which measured sensor data 250 is compared. Thus, machine learning enables a more accurate inference of pedestrian lagging. In this way, the classification module 225 identifies pedestrian behaviors that may negatively impact their safety and traffic, both vehicle and pedestrian, such that appropriate countermeasures may be provided to improve traffic flow, reduce potentially dangerous traffic situations, and reduce vehicle emissions.

Moreover, it should be appreciated that machine learning algorithms are generally trained to perform a defined task. Thus, the training of the machine learning algorithm is understood to be distinct from the general use of the machine learning algorithm unless otherwise stated. That is, the group restoration system 170 or another system generally trains the machine learning algorithm according to a particular training approach, which may include supervised training, self-supervised training, reinforcement learning, and so on. In contrast to training/learning of the machine learning algorithm, the group restoration system 170 implements the machine learning algorithm to perform inference. Thus, the general use of the machine learning algorithm is described as inference.

It should be appreciated that the classification module 225, in combination with the classification model 255, can form a computational model such as a neural network model. In any case, the classification module 225, when implemented with a neural network model or another model in one embodiment, implements functional aspects of the classification model 255 while further aspects, such as learned weights, may be stored within the data store 240. Accordingly, the classification model 255 is generally integrated with the classification module 225 as a cohesive, functional structure.

The group restoration system 170 further includes a countermeasure module 230 which, in one embodiment, includes instructions that cause the processor 110 to produce a group restoration countermeasure responsive to the pedestrian being classified as isolated from the group. As such, the countermeasure module 230 is communicatively coupled to the classification module 225 to receive a classification for the pedestrian and encourage the pedestrian to join the group. As described above, a pedestrian that travels in the same direction as a group of pedestrians, for example while crossing a road, but at a slower speed than the group, may impair efficient vehicle and pedestrian travel. This is exacerbated as multiple pedestrians lag behind a group, in some examples forming a string of individual pedestrians crossing a road rather than a single group. Such behavior may also result in other adverse situations, such as blocked intersections, traffic congestion, and slowdowns. These and other situations may increase the risk to pedestrians and vehicles alike. As such, the countermeasure module 230 generates outputs that promote group pedestrian movement.

The group restoration countermeasure may take a variety of forms. In one example, the countermeasure is a visual or audible notification, message, or instruction to the pedestrian to join the group. Such a notification, message, or instruction may originate from the vehicle 100, an infrastructure element, or a user device of the pedestrian. For example, a vehicle may include lighting elements such as headlights, an external display panel, and/or external speakers. Through these output devices, the vehicle 100 may generate a notification tone, a verbal message, a flashing light indication, or a textual display instructing the pedestrian to join the group.

As another example, any number of infrastructure elements in the vicinity of the pedestrian may similarly include lighting elements, external display panels, and/or external speakers. These output devices may generate a notification tone, verbal message, flashing light indication, or a textual display instructing the pedestrian to join the group.

As yet another example, a notification tone, verbal message, flashing light indication, textual display, or any other of a variety of notifications may be presented on a user device of the pedestrian. For example, a user may be listening to music on their smartphone while crossing a road. In this example, the notification may interrupt the music to instruct the pedestrian.

In an example, the notification may be to pedestrians in the group. For example, a lead pedestrian of the group, or any pedestrian in the group, could be encouraged to slow the pace of travel to more closely match the pace of the lagging pedestrian. Similar to encouraging the straggling pedestrian to speed up, encouraging the group to slow down reduces the wait times (of both the pedestrians and vehicles) at intersections. As such, in this example the countermeasure module 230 includes instructions that cause the processor 110 to generate a recommendation to the group to alter a pace of travel.

In any of these examples, the group restoration system 170 may communicate with the source of the notification (e.g., the vehicle, infrastructure element, or user device) via the communication system 180. Note that while particular reference is made to particular notifications, other types of audible or visual notifications may be presented to prompt the pedestrian to join the group.

In an example, the countermeasure module 230 includes instructions that cause the processor 110 to impair the operational capability of a user device of the pedestrian. That is, the countermeasure module 230 may negatively impact the operation of the user device to incentivize the pedestrian to remain near the group. Examples of limiting user device operational capability include shutting off or reducing 1) the volume of music playing on a user device, 2) data transmission rates/bandwidth, and/or 3) wireless connectivity. For example, responsive to the pedestrian being classified as lagging behind or isolated from a group while traveling in the same direction as the group, the countermeasure module 230 may turn off or turn down the music playing on a user device of the pedestrian. In an example, the reduction in volume may be based on the distance of the pedestrian from the group, with the music playing more quietly the farther away the pedestrian is from the group. In some examples, the operational capability (e.g., the music volume) may be restored upon the pedestrian rejoining the group. While particular reference is made to certain operational capabilities of a user device that are shut off or reduced, the countermeasure module 230 may alter other operational capabilities of the user device of the pedestrian.

The disabling of the operational capability of the user device may occur in a variety of ways. For example, via a V2P communication framework, the group restoration system 170 may transmit a command signal to the user device that updates or alters any of the settings/policies of the user device. As another example, a user device manufacturer may preload remote support tools on a user device. In this example, the countermeasure module 230 may interact with the remote support tools to disrupt service or alter the policies/settings of the user device based on the owner of the user device being classified as a lagging pedestrian.

As another specific example, the group restoration system 170, via a communication system 180, may communicate with an Internet Service Provider (ISP), mobile network provider, or an application on the user device to throttle the bandwidth and/or limit the data connection speed provided to the user device. In an example, the bandwidth throttling countermeasure may limit the types of data (such as streaming videos/audio) or limit the data used by specific applications or websites (e.g., web browsing, video streaming, and online gaming) that are accessible. In this example, the bandwidth reduction may be based on the distance of the pedestrian from the group, with the bandwidth being less the farther away the pedestrian is from the group.

In any case, the group restoration system 170, either directly or indirectly through an ISP, mobile network provider, or device management entity, may alter the settings, policies, or operational characteristics of a user device of the pedestrian responsive to the pedestrian being identified as lagging behind a group traveling in a same direction.

In an example, the countermeasure module 230 includes instructions that cause the processor 110 to provide an incentive to the pedestrian, responsive to the pedestrian being within a threshold distance from the group. In an example, this incentive may be to increase the operational capability of a user device of the pedestrian. That is, just as the group restoration system 170, either directly or indirectly through an ISP mobile network provider or other device management entity, may negatively impact device functionalities such as wireless data transmission speeds, bandwidth, and/or applications and website accessibility, the group restoration system 170 can increase the operability of the user device in these areas. For example, the group restoration system 170 may, through the ISP or mobile network provider, provide greater data transmission speeds the closer the pedestrian is to the center of the group. As another example of an incentive, the countermeasure module 230 may provide credits, such as electronic credits for public transportation, to the pedestrian responsive to the pedestrian within a threshold distance from the group or within the group.

As such, the group restoration system 170 reduces traffic congestion and promotes efficient vehicle-pedestrian interactions by identifying those pedestrians who are with a group but lagging behind the group and then generating any number of countermeasures, which may include audible/visual notifications, warnings, or messages and in some cases altering user device capability based on the pedestrian lagging behind a group. Moreover, the group restoration system 170 promotes pedestrian and vehicle safety by preventing the dangerous circumstances that may arise from a pedestrian declining to travel with a group, which dangerous circumstances include traffic congestion and blocking intersections. Still further, the group restoration system 170 reduces vehicle emissions by reducing the time that vehicles are idle as they wait for lagging pedestrians (in some examples, multiple individual lagging pedestrians) to cross a roadway.

FIGS. 3A-3C illustrate a group restoration system 170 encouraging a first pedestrian 362 to rejoin a group 370 of pedestrians. Specifically, FIGS. 3A-3C depict a group 370 of pedestrians crossing a road, with a first pedestrian 362 lagging, but traveling in the same direction as the group 370. As depicted in FIG. 3A, this lagging behavior causes the vehicle 100 to delay its navigation across the roadway until the first pedestrian 362 has crossed the road. Thus, the lagging behavior causes traffic delays, traffic congestion, increased emissions, and potentially poses a safety risk. This problem is exacerbated as additional pedestrians straggle behind, forming a string of straggling pedestrians. These undesirable conditions (e.g., traffic delay, traffic congestion, increased emissions, and safety risks) may be reduced were the first pedestrian 362 to join the group 370 across the road. As such, the group restoration system 170 of the present specification generates an output that prompts such a reunion.

In an example, the group restoration system 170 is triggered by environmental conditions. For example, rather than continuously analyzing an environment for groups 370 of pedestrians and identifying pedestrians that are lagging, isolated, or otherwise removed from the group 370, the group restoration system 170 may perform the operations described in the present specification responsive to some event. For example, the group restoration system 170 may be triggered when 1) the sensor system 120 of the vehicle 100 identifies a crosswalk, 2) a turn signal of the vehicle 100 is active, and/or 3) the vehicle 100 is stopped before the crosswalk. As such, the behavior module 220 and the classification module 225 may perform their respective functions responsive to the identification of a pedestrian and group of pedestrians at a crosswalk of a roadway. While particular reference is made to particular triggers, other triggers may similarly activate the group restoration system 170 of the present specification.

As described above, either the vehicle 100, another vehicle, or an infrastructure element 360 may include an environment sensor such as a camera that captures images of the environment, which environment includes dynamic objects such as a group 370 of pedestrians, a first pedestrian 362 who is straggling/lagging behind the group 370, and a second pedestrian 364 who is unaffiliated with the group 370 on account of traveling in a different direction.

The behavior module 220 described earlier may include an instruction that causes the processor 110 to identify and track the objects (e.g., pedestrians) in the captured images. For example, the behavior module 220 may determine the location of the group 370, first pedestrian 362, and second pedestrian 364 in different video stream frames. In an example, the behavior module 220 may also determine the direction of travel and speed of travel of the group 370, first pedestrian 362, and second pedestrian 364. As described above, any of this information may be used to determine which pedestrians form the group 370 and which pedestrians, if any, are lagging behind the group 370 and should thus be a target of a group restoration countermeasure.

As described above, the classification module 225 may rely on different criteria to determine whether a pedestrian is lagging behind the group 370 and should be prompted to join or re-join the group 370. In one example, the criteria is distance. In this example, the criteria may be a static threshold or a static threshold over time. For example, a pedestrian greater than one meter away from the group or greater than one meter away from the group for a threshold amount of time may be lagging behind the group. In another example, the threshold may be based on the characteristics of the group 370. For example, the threshold may be based on a dimension of the group 370 (e.g., the width of the group) or the number of pedestrians in the group 370. As a specific example, the threshold distance for the group 370 against which lagging pedestrians are defined may be larger for groups 370 with more pedestrians than groups 370 with fewer pedestrians. As yet another example, the threshold distance may be a statistical evaluation. For example, those pedestrians that are one, two, or three standard deviations away from the group 370 may be identified as lagging behind the group 370, wherein a standard deviation is defined by any number of criteria, including a width of the group 370 or a center of the group 370.

In the example where the lagging criteria include at least one of a direction of travel and speed of travel, the criteria may be static thresholds or static thresholds over time. For example, a pedestrian who is 1) traveling in a direction that is the same as the direction of travel of the group, or is within a threshold range from the direction of travel of the group 370 and 2) traveling at a speed that is different than the speed of the group 370 or outside of a threshold range of the speed of the group 370, may be determined to be lagging behind the group.

For example, as depicted in FIG. 3A, the first pedestrian 362 may be traveling in the same direction as the group 370 (e.g., leftward across the crosswalk) and may be traveling at a speed that is less than, or outside of a threshold range, of the speed of the group 370. As such, the first pedestrian 362 may be determined to be lagging behind the group 370 and, therefore, a target of a group restoration countermeasure. By comparison, the second pedestrian 364 may be traveling in a different direction or outside of a threshold range of the group 370 travel direction. As such, the second pedestrian 364 is deemed unaffiliated with the group 370 and is not a target of a group restoration countermeasure. As such, the classification module 225 includes instructions that cause the processor 110 to differentiate a group-associated pedestrian (e.g., the first pedestrian 362) from a pedestrian that is unaffiliated with the group (e.g., the second pedestrian 364) based on the movement behavior of the pedestrian(s) and the movement behavior of the group 370.

As described above, the classification of a pedestrian as lagging may be based on any number or combination of criteria such as the location of the pedestrian and group 370, the direction of travel of the pedestrian and group 370, and/or the speed of travel of the pedestrian and group 370. Note that while particular examples of criteria are described (i.e., 1) location and 2) speed and direction of travel), other criteria and other combinations of criteria may be relied on to determine whether a pedestrian is lagging behind a group 370 they should be prompted to join. For example, the classification module 225 may classify a pedestrian based on locational differences between the pedestrians and the group 370 and the direction of travel of the pedestrian and the group.

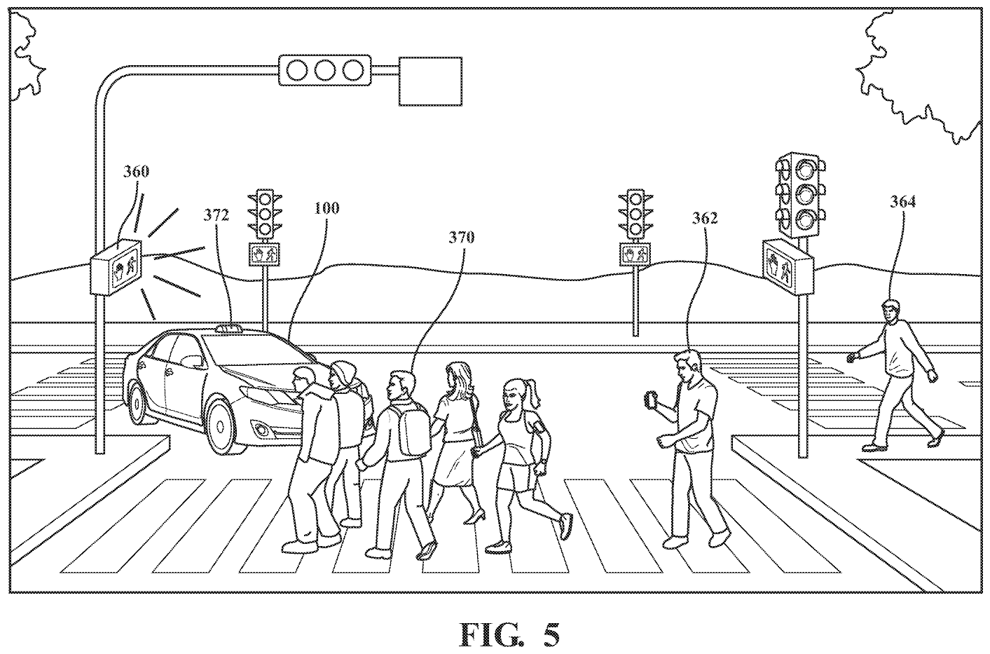

As depicted in FIG. 3B, once the first pedestrian 362 has been identified as a lagging pedestrian, the countermeasure module 230 generates a countermeasure that prompts and/or incentivizes the first pedestrian 362, who is lagging, to quicken pace or otherwise join the group 370. As described above, a notification may take various forms, including a visual or audible notification from a vehicle 100, infrastructure element 360, or the user device of the lagging first pedestrian 362. In the example depicted in FIG. 3B, the vehicle 100 includes an external speaker 372 that produces an audible tone, warning message, or notification targeted to prompt the first pedestrian 362 to rejoin the group 370. FIG. 5 below depicts a similar example where the audible tone, warning message, or notification is provided from a speaker mounted on an infrastructure element 360. Note that while the figures depict and describe audible notifications, the countermeasure module 230 may generate visual notifications, such as flashing lights or a text message on an external display device of the vehicle 100 or the infrastructure element 360. In either case, the countermeasure module 230 includes instructions that cause the processor 110 to instruct at least one of a vehicle in the vicinity of the group 370 of pedestrians or an infrastructure element 36—in the vicinity of the group 370 of pedestrians to generate the audible or visual recommendation.

In an example, the intensity of the countermeasure may be based on a degree of deviation between the movement behavior of the pedestrian and the movement behavior of the group 370. That is, various criteria have been presented as triggering the generation of a countermeasure, and the degree of difference between the behavior of the pedestrian 362 and the behavior of the group 370 may dictate the intensity of the countermeasure. For example, lagging pedestrians that are further behind and are traveling more slowly than the group 370 may trigger louder audio tones/messages and/or more conspicuous visual messages than were the pedestrian closer to the group 370 with a speed more closely matched to the group 370 (while still outside threshold ranges).

As depicted in FIG. 3C, responsive to the countermeasure, the lagging first pedestrian 362 may join the group 370, such that the vehicle path is cleared more quickly than had the countermeasure not been provided. As such, the group restoration system 170 reduces traffic congestion and promotes efficient vehicle-pedestrian interactions by identifying those pedestrians who are with a group but lagging behind such and then generating any number of countermeasures, which may include audible/visual notifications, warnings, or messages and in some cases altering user device capability based on the pedestrian lagging behind a group.

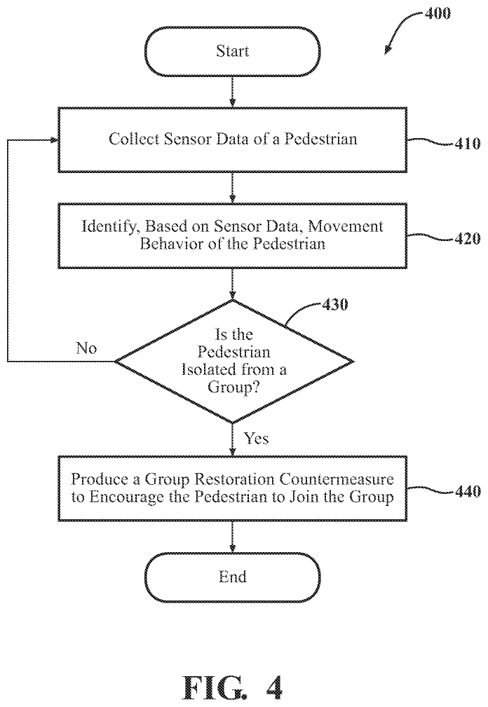

Additional aspects of encouraging group pedestrian movement will be discussed in relation to FIG. 4. FIG. 4 illustrates a flowchart of a method 400 that is associated with identifying lagging pedestrians and providing countermeasures (such as visual or audible notifications and/or altering user device operational capability) to encourage the lagging pedestrian to join the group 370. Method 400 will be discussed from the perspective of the group restoration system 170 of FIGS. 1 and 2. While method 400 is discussed in combination with the group restoration system 170, it should be appreciated that the method 400 is not limited to being implemented within the group restoration system 170 but is instead one example of a system that may implement the method 400.

At 410, the group restoration system 170 collects sensor data 250. As described above, the sensor data 250 includes images or other environment sensor outputs that depict the surrounding environment including objects such as pedestrians within the environment. As such, the behavior module 220 controls the sensor system 120 of the vehicle 100 to acquire the sensor data 250 and/or communicates with infrastructure element sensor systems to acquire the sensor data 250. In one embodiment, the behavior module 220 controls the radar sensor 123 and the camera 126 of the vehicle 100 and/or an infrastructure element 360 to observe the surrounding environment. Alternatively, or additionally, the behavior module 220 controls the camera 126 and the LiDAR sensor 124 or another set of sensors to acquire the sensor data 250. As part of controlling the sensors to acquire the sensor data 250, it is generally understood that the sensors acquire the sensor data 250 of a region around the ego vehicle 100 with data acquired from different types of sensors generally overlapping in order to provide for a comprehensive sampling of the surrounding environment at each time step. In general, the sensor data 250 need not be of the exact same bounded region in the surrounding environment but should include a sufficient area of overlap such that distinct aspects of the area can be correlated. Thus, the behavior module 220, in one embodiment, controls the sensors to acquire the sensor data 250 of the surrounding environment.

Moreover, in further embodiments, the behavior module 220 controls the sensors to acquire the sensor data 250 at successive iterations or time steps. Thus, the group restoration system 170, in one embodiment, iteratively executes the functions discussed at blocks 410-430 to acquire the sensor data 250 and provide information therefrom. Furthermore, the behavior module 220, in one embodiment, executes one or more of the noted functions in parallel for separate observations in order to maintain updated perceptions. Additionally, as previously noted, the behavior module 220, when acquiring data from multiple sensors, fuses the data together to form the sensor data 250 and to provide for improved determinations of detection, location, and so on.

At 420, the behavior module 220 identifies, based on the sensor data 250, the movement behavior of the pedestrian. Identifying movement behaviors may include tracking the pedestrian through various video stream frames to determine the location, direction of travel, and speed of travel for each pedestrian identified in the images or other perceptual sensor output.

At 430, the classification module 225 determines whether the pedestrian is isolated, lagging, or otherwise removed from the group 370 of pedestrians. As described above, such a determination may be based on the location, direction of travel, and/or speed of the pedestrian as compared to the location, direction of travel, and/or speed of the group 370 of pedestrians. Specifically, if the movement behavior of the pedestrian is a threshold amount different than the movement behavior of the group 370, the pedestrian is classified as lagging behind the group 370 and should thus be targeted for group restoration countermeasures.

As described above, in some examples, such a classification may be based on machine learning that compares the sensor data 250 to baseline data indicative of expected behavior, which machine learning system is trained based on historical patterns identified from other pedestrians. In any case, if the pedestrian is not isolated, lagging, or otherwise removed from the group 370 of pedestrians as indicated by the respective movement behavior data, the behavior module 220 continues to collect sensor data 250 and monitor the movement behavior of the group 370 and other pedestrians.

If the pedestrian is isolated, at 440, the countermeasure module 230 produces a group restoration countermeasure, encouraging the pedestrian to join the group 370. As described above, the countermeasure may be a notification/warning to the pedestrian. In an example, the countermeasure alters the operability of a user device of the pedestrian to encourage the pedestrian to move closer to the group 370. For example, user device capabilities/functionalities may be reduced or turned off based on the pedestrian lagging behind a group 370 and may be restored once the pedestrian joins the group 370. In some examples, pedestrians and/or groups may opt out of the group restoring countermeasures. For example, a pedestrian may leave the group 370 and thus not be the target of determined countermeasures. In another example, the group 370 may identify and remove a pedestrian improperly classified as part of the group 370. As such, the present system, methods, and other embodiments promote the safety and efficiency of roadway traffic.

FIG. 5 illustrates one embodiment of a group restoration system 170 that is associated with encouraging pedestrian group movement. As described above in connection with FIG. 3B, the countermeasure may be provided by a vehicle 100. In the example depicted in FIG. 5, the infrastructure element 360 includes an external speaker that produces an audible tone, warning message, or notification targeted to prompt the first pedestrian 362 to rejoin the group 370. While the figures depict and describe audible notifications, the countermeasure module 230 may generate visual notifications, such as flashing lights or a text message on an external display device of infrastructure element 360.

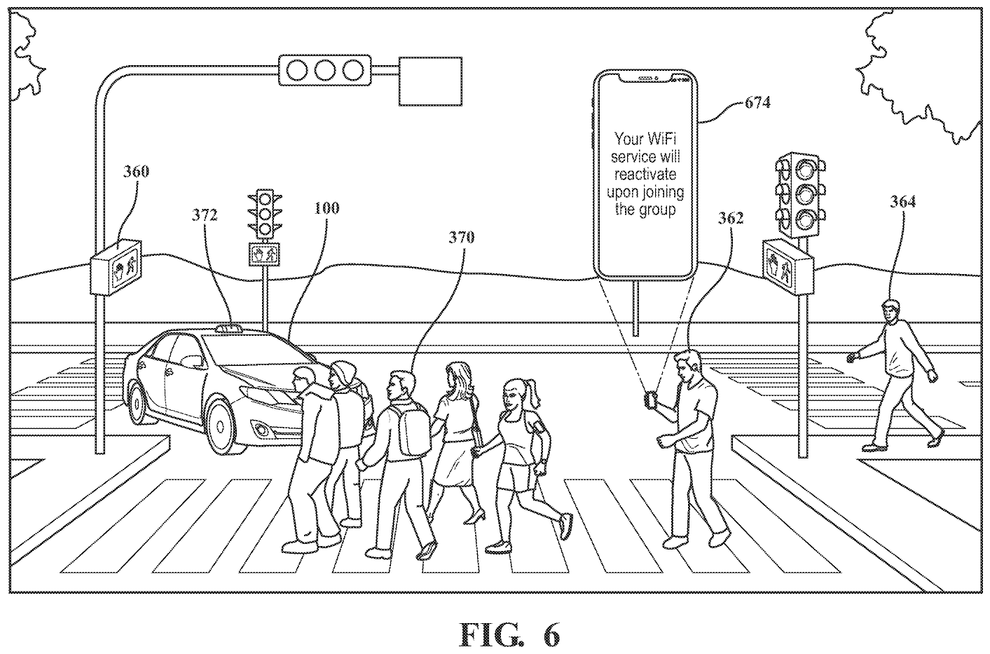

FIG. 6 illustrates one embodiment of a group restoration system 170 that is associated with encouraging pedestrian group movement. As described above, in some examples, the group restoration countermeasure alters the operation of the user device 674 of the lagging pedestrian to incentivize the pedestrian to join or rejoin the group 370. The incentive may take a variety of forms. For example, responsive to the first pedestrian 362 being identified as lagging, the countermeasure module 230 may reduce the functional capability or turn off the functional capability of some features of the user device 674. For example, via an ISP, mobile network provider, or user device management application, the countermeasure module 230 may alter the settings and/or policies of the user device 674 to reduce the operability of the user device 674.

As a specific example, the countermeasure module 230 may turn down the volume on a music application or disable a music application when the pedestrian is lagging behind a group 370. The capability may be restored once the pedestrian rejoins the group 370, as depicted in FIG. 3C. In another example, the countermeasure module 230 may, in some examples, in coordination with a mobile ISP, reduce data transmission speeds, reduce data transmission bandwidth, prevent certain types of data transfers, prevent access to certain websites/applications on a phone, responsive to the pedestrian being identified as lagging behind a group 370. Service may be restored once the pedestrian rejoins the group 370, as depicted in FIG. 3C. In some examples, a notification may be presented to the pedestrian via the display of the user device 674, which notifies the pedestrian of the operational capability reduction and provides a notification of an action that will restore operational capability.

FIG. 1 will now be discussed in full detail as an example environment within which the system and methods disclosed herein may operate. In some instances, the vehicle 100 is configured to switch selectively between an autonomous mode, one or more semi-autonomous modes, and/or a manual mode. “Manual mode” means that all of or a majority of the control and/or maneuvering of the vehicle is performed according to inputs received via manual human-machine interfaces (HMIs) (e.g., steering wheel, accelerator pedal, brake pedal, etc.) of the vehicle 100 as manipulated by a user (e.g., human driver). In one or more arrangements, the vehicle 100 can be a manually-controlled vehicle that is configured to operate in only the manual mode.

In one or more arrangements, the vehicle 100 implements some level of automation in order to operate autonomously or semi-autonomously. As used herein, automated control of the vehicle 100 is defined along a spectrum according to the SAE J3016 standard. The SAE J3016 standard defines six levels of automation from level zero to five. In general, as described herein, semi-autonomous mode refers to levels zero to two, while autonomous mode refers to levels three to five. Thus, the autonomous mode generally involves control and/or maneuvering of the vehicle 100 along a travel route via a computing system to control the vehicle 100 with minimal or no input from a human driver. By contrast, the semi-autonomous mode, which may also be referred to as advanced driving assistance system (ADAS), provides a portion of the control and/or maneuvering of the vehicle via a computing system along a travel route with a vehicle operator (i.e., driver) providing at least a portion of the control and/or maneuvering of the vehicle 100.

With continued reference to the various components illustrated in FIG. 1, the vehicle 100 includes one or more processors 110. In one or more arrangements, the processor(s) 110 can be a primary/centralized processor of the vehicle 100 or may be representative of many distributed processing units. For instance, the processor(s) 110 can be an electronic control unit (ECU). Alternatively, or additionally, the processors include a central processing unit (CPU), a graphics processing unit (GPU), an ASIC, a microcontroller, a system on a chip (SoC), and/or other electronic processing units that support operation of the vehicle 100.

The vehicle 100 can include one or more data stores 115 for storing one or more types of data. The data store 115 can be comprised of volatile and/or non-volatile memory. Examples of memory that may form the data store 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, solid-state drivers (SSDs), and/or other non-transitory electronic storage medium. In one configuration, the data store 115 is a component of the processor(s) 110. In general, the data store 115 is operatively connected to the processor(s) 110 for use thereby. The term “operatively connected,” as used throughout this description, can include direct or indirect connections, including connections without direct physical contact.

In one or more arrangements, the one or more data stores 115 include various data elements to support functions of the vehicle 100, such as semi-autonomous and/or autonomous functions. Thus, the data store 115 may store map data 116 and/or sensor data 119. The map data 116 includes, in at least one approach, maps of one or more geographic areas. In some instances, the map data 116 can include information about roads (e.g., lane and/or road maps), traffic control devices, road markings, structures, features, and/or landmarks in the one or more geographic areas. The map data 116 may be characterized, in at least one approach, as a high-definition (HD) map that provides information for autonomous and/or semi-autonomous functions.

In one or more arrangements, the map data 116 can include one or more terrain maps 117. The terrain map(s) 117 can include information about the ground, terrain, roads, surfaces, and/or other features of one or more geographic areas. The terrain map(s) 117 can include elevation data in the one or more geographic areas. In one or more arrangements, the map data 116 includes one or more static obstacle maps 118. The static obstacle map(s) 118 can include information about one or more static obstacles located within one or more geographic areas. A “static obstacle” is a physical object whose position and general attributes do not substantially change over a period of time. Examples of static obstacles include trees, buildings, curbs, fences, and so on.

The sensor data 119 is data provided from one or more sensors of the sensor system 120. Thus, the sensor data 119 may include observations of a surrounding environment of the vehicle 100 and/or information about the vehicle 100 itself. In some instances, one or more data stores 115 located onboard the vehicle 100 store at least a portion of the map data 116 and/or the sensor data 119. Alternatively, or in addition, at least a portion of the map data 116 and/or the sensor data 119 can be located in one or more data stores 115 that are located remotely from the vehicle 100.

As noted above, the vehicle 100 can include the sensor system 120. The sensor system 120 can include one or more sensors. As described herein, “sensor” means an electronic and/or mechanical device that generates an output (e.g., an electric signal) responsive to a physical phenomenon, such as electromagnetic radiation (EMR), sound, etc. The sensor system 120 and/or the one or more sensors can be operatively connected to the processor(s) 110, the data store(s) 115, and/or another element of the vehicle 100.

Various examples of different types of sensors will be described herein. However, it will be understood that the embodiments are not limited to the particular sensors described. In various configurations, the sensor system 120 includes one or more vehicle sensors 121 and/or one or more environment sensors. The vehicle sensor(s) 121 function to sense information about the vehicle 100 itself. In one or more arrangements, the vehicle sensor(s) 121 include one or more accelerometers, one or more gyroscopes, an inertial measurement unit (IMU), a dead-reckoning system, a global navigation satellite system (GNSS), a global positioning system (GPS), and/or other sensors for monitoring aspects about the vehicle 100.

As noted, the sensor system 120 can include one or more environment sensors 122 that sense a surrounding environment (e.g., external) of the vehicle 100 and/or, in at least one arrangement, an environment of a passenger cabin of the vehicle 100. For example, the one or more environment sensors 122 sense objects the surrounding environment of the vehicle 100. Such obstacles may be stationary objects and/or dynamic objects. Various examples of sensors of the sensor system 120 will be described herein. The example sensors may be part of the one or more environment sensors 122 and/or the one or more vehicle sensors 121. However, it will be understood that the embodiments are not limited to the particular sensors described. As an example, in one or more arrangements, the sensor system 120 includes one or more radar sensors 123, one or more LiDAR sensors 124, one or more sonar sensors 125 (e.g., ultrasonic sensors), and/or one or more cameras 126 (e.g., monocular, stereoscopic, RGB, infrared, etc.).

Continuing with the discussion of elements from FIG. 1, the vehicle 100 can include an input system 130. The input system 130 generally encompasses one or more devices that enable the acquisition of information by a machine from an outside source, such as an operator. The input system 130 can receive an input from a vehicle passenger (e.g., a driver/operator and/or a passenger). Additionally, in at least one configuration, the vehicle 100 includes an output system 135. The output system 135 includes, for example, one or more devices that enable information/data to be provided to external targets (e.g., a person, a vehicle passenger, another vehicle, another electronic device, etc.).

Furthermore, the vehicle 100 includes, in various arrangements, one or more vehicle systems 140. Various examples of the one or more vehicle systems 140 are shown in FIG. 1. However, the vehicle 100 can include a different arrangement of vehicle systems. It should be appreciated that although particular vehicle systems are separately defined, each or any of the systems or portions thereof may be otherwise combined or segregated via hardware and/or software within the vehicle 100. As illustrated, the vehicle 100 includes a propulsion system 141, a braking system 142, a steering system 143, a throttle system 144, a transmission system 145, a signaling system 146, and a navigation system 147.

The navigation system 147 can include one or more devices, applications, and/or combinations thereof to determine the geographic location of the vehicle 100 and/or to determine a travel route for the vehicle 100. The navigation system 147 can include one or more mapping applications to determine a travel route for the vehicle 100 according to, for example, the map data 116. The navigation system 147 may include or at least provide connection to a global positioning system, a local positioning system or a geolocation system.

In one or more configurations, the vehicle systems 140 function cooperatively with other components of the vehicle 100. For example, the processor(s) 110, the group restoration system 170, and/or automated driving module(s) 160 can be operatively connected to communicate with the various vehicle systems 140 and/or individual components thereof. For example, the processor(s) 110 and/or the automated driving module(s) 160 can be in communication to send and/or receive information from the various vehicle systems 140 to control the navigation and/or maneuvering of the vehicle 100. The processor(s) 110, the group restoration system 170, and/or the automated driving module(s) 160 may control some or all of these vehicle systems 140.

For example, when operating in the autonomous mode, the processor(s) 110, and/or the automated driving module(s) 160 control the heading and speed of the vehicle 100. The processor(s) 110 and/or the automated driving module(s) 160 cause the vehicle 100 to accelerate (e.g., by increasing the supply of energy/fuel provided to a motor), decelerate (e.g., by applying brakes), and/or change direction (e.g., by steering the front two wheels). As used herein, “cause” or “causing” means to make, force, compel, direct, command, instruct, and/or enable an event or action to occur either in a direct or indirect manner.

As shown, the vehicle 100 includes one or more actuators 150 in at least one configuration. The actuators 150 are, for example, elements operable to move and/or control a mechanism, such as one or more of the vehicle systems 140 or components thereof responsive to electronic signals or other inputs from the processor(s) 110 and/or the automated driving module(s) 160. The one or more actuators 150 may include motors, pneumatic actuators, hydraulic pistons, relays, solenoids, piezoelectric actuators, and/or another form of actuator that generates the desired control.

As described previously, the vehicle 100 can include one or more modules, at least some of which are described herein. In at least one arrangement, the modules are implemented as non-transitory computer-readable instructions that, when executed by the processor 110, implement one or more of the various functions described herein. In various arrangements, one or more of the modules are a component of the processor(s) 110, or one or more of the modules are executed on and/or distributed among other processing systems to which the processor(s) 110 is operatively connected. Alternatively, or in addition, the one or more modules are implemented, at least partially, within hardware. For example, the one or more modules may be comprised of a combination of logic gates (e.g., metal-oxide-semiconductor field-effect transistors (MOSFETs)) arranged to achieve the described functions, an application-specific integrated circuit (ASIC), programmable logic array (PLA), field-programmable gate array (FPGA), and/or another electronic hardware-based implementation to implement the described functions. Further, in one or more arrangements, one or more of the modules can be distributed among a plurality of the modules described herein. In one or more arrangements, two or more of the modules described herein can be combined into a single module.

Furthermore, the vehicle 100 may include one or more automated driving modules 160. The automated driving module(s) 160, in at least one approach, receive data from the sensor system 120 and/or other systems associated with the vehicle 100. In one or more arrangements, the automated driving module(s) 160 use such data to perceive a surrounding environment of the vehicle. The automated driving module(s) 160 determine a position of the vehicle 100 in the surrounding environment and map aspects of the surrounding environment. For example, the automated driving module(s) 160 determines the location of obstacles or other environmental features including traffic signs, trees, shrubs, neighboring vehicles, pedestrians, etc.

The automated driving module(s) 160 either independently or in combination with the group restoration system 170 can be configured to determine travel path(s), current autonomous driving maneuvers for the vehicle 100, future autonomous driving maneuvers and/or modifications to current autonomous driving maneuvers based on data acquired by the sensor system 120 and/or another source. In general, the automated driving module(s) 160 functions to, for example, implement different levels of automation, including advanced driving assistance (ADAS) functions, semi-autonomous functions, and fully autonomous functions, as previously described.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-6, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. The systems, components and/or processes also can be embedded in a computer-readable storage, such as a computer program product or other data program storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. A non-exhaustive list of the computer-readable storage medium can include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or a combination of the foregoing. In the context of this document, a computer-readable storage medium is, for example, a tangible medium that stores a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system, comprising:
a processor; and
a memory storing machine-readable instructions that, when executed by the processor, cause the processor to:
identify, based on sensor data, a movement behavior of a pedestrian;
classify the pedestrian as trailing behind a group of pedestrians based on the movement behavior of the pedestrian and a movement behavior of the group; and
produce a group restoration countermeasure responsive to the pedestrian being classified as trailing behind the group, the group restoration countermeasure encourages the pedestrian to join the group.

2. The system of claim 1, wherein the machine-readable instruction that, when executed by the processor, causes the processor to classify the pedestrian as trailing behind the group of pedestrians comprises a machine-readable instruction that, when executed by the processor causes the processor to classify the pedestrian responsive to the pedestrian and the group of pedestrians crossing a roadway.

3. The system of claim 1, wherein:
the machine-readable instruction that, when executed by the processor, causes the processor to identify the movement behavior of the pedestrian comprises a machine-readable instruction that, when executed by the processor, causes the processor to identify a location of the pedestrian; and
the machine-readable instruction that, when executed by the processor, causes the processor to classify the pedestrian as being isolated from the group of pedestrians comprises a machine-readable instruction that, when executed by the processor, causes the processor to classify the pedestrian as being isolated from the group when the location of the pedestrian is a threshold distance away from a location of the group.

4. The system of claim 1, wherein:
the machine-readable instruction that, when executed by the processor, causes the processor to identify the movement behavior of the pedestrian comprises a machine-readable instruction that, when executed by the processor, causes the processor to identify:
a direction of travel of the pedestrian; and
a velocity of the pedestrian; and
the machine-readable instruction that, when executed by the processor, causes the processor to classify the pedestrian as being isolated from the group of pedestrians comprises a machine-readable instruction that, when executed by the processor, causes the processor to classify the pedestrian as being isolated from the group based on:
the direction of travel of the pedestrian being within a threshold range from a direction of travel of the group; and
the velocity of the pedestrian being greater than a threshold difference from a velocity of the group.

5. The system of claim 1, wherein the machine-readable instruction that, when executed by the processor, causes the processor to identify, based on sensor data, the movement behavior of the pedestrian, further comprises a machine-readable instruction that, when executed by the processor, causes the processor to identify the movement behavior of the pedestrian based on sensor data collected from at least one of an infrastructure environment sensor or a vehicle environment sensor.

6. The system of claim 1, wherein the machine-readable instruction that, when executed by the processor, causes the processor to classify the pedestrian as being isolated from the group of pedestrians comprises a machine-readable instruction that, when executed by the processor, causes the processor to differentiate a group-associated pedestrian from a pedestrian unaffiliated with the group based on the movement behavior of the pedestrian and the movement behavior of the group of pedestrians.

7. The system of claim 1, wherein the machine-readable instruction that, when executed by the processor, causes the processor to classify the pedestrian as being isolated from the group of pedestrians comprises a machine-learning instruction that, when executed by the processor, causes the processor to compare the movement behavior of the pedestrian to baseline movement behavior.

8. The system of claim 1, wherein the machine-readable instruction that, when executed by the processor, causes the processor to produce the group restoration countermeasure comprises a machine-readable instruction that, when executed by the processor, causes the processor to generate an audible or visual recommendation to the pedestrian to join the group.

9. The system of claim 8, wherein the machine-readable instruction that, when executed by the processor, causes the processor to generate the audible or visual recommendation comprises a machine-readable instruction that, when executed by the processor, causes the processor to instruct at least one of a vehicle in a vicinity of the group of pedestrians or an infrastructure element in the vicinity of the group of pedestrians to generate the audible or visual recommendation.

10. The system of claim 1, wherein the machine-readable instruction that, when executed by the processor, causes the processor to produce the group restoration countermeasure comprises a machine-readable instruction that, when executed by the processor, causes the processor to generate a recommendation to the group to alter a pace of travel.

11. The system of claim 1, wherein the machine-readable instruction that, when executed by the processor, causes the processor to produce the group restoration countermeasure comprises a machine-readable instruction that, when executed by the processor, causes the processor to impair an operational capability of a user device of the pedestrian.

12. The system of claim 1, wherein the machine-readable instruction that, when executed by the processor, causes the processor to produce the group restoration countermeasure comprises a machine-readable instruction that, when executed by the processor, causes the processor to provide an incentive to the pedestrian responsive to the pedestrian being within a threshold distance from the group.

13. The system of claim 1, wherein the machine-readable instruction that, when executed by the processor, causes the processor to produce the group restoration countermeasure comprises a machine-readable instruction that, when executed by the processor, causes the processor to provide the group restoration countermeasure with an intensity that is based on a degree of deviation between the movement behavior of the pedestrian and the movement behavior of the group.

14. A non-transitory machine-readable medium comprising instructions that, when executed by a processor, cause the processor to:
identify, based on sensor data, a movement behavior of a pedestrian;
classify the pedestrian as being isolated from a group of pedestrians based on the movement behavior of the pedestrian and a movement behavior of the group; and
produce a group restoration countermeasure responsive to the pedestrian being classified as isolated from the group, the group restoration countermeasure encourages the pedestrian to join the group.

15. The non-transitory machine-readable medium of claim 14, wherein:
the instruction that, when executed by the processor, causes the processor to identify the movement behavior of the pedestrian comprises an instruction that, when executed by the processor, causes the processor to identify a location of the pedestrian; and
the instruction that, when executed by the processor, causes the processor to classify the pedestrian as being isolated from the group of pedestrians comprises an instruction that, when executed by the processor, causes the processor to classify the pedestrian as being isolated from the group when the location of the pedestrian is a threshold distance away from a location of the group.

16. The non-transitory machine-readable medium of claim 14, wherein:
the instruction that, when executed by the processor, causes the processor to identify the movement behavior of the pedestrian comprises an instruction that, when executed by the processor, causes the processor to identify:
a direction of travel of the pedestrian; and
a velocity of the pedestrian; and
the instruction that, when executed by the processor, causes the processor to classify the pedestrian as being isolated from the group of pedestrians comprises an instruction that, when executed by the processor, causes the processor to classify the pedestrian as being isolated from the group based on:
the direction of travel of the pedestrian being within a threshold difference from a direction of travel of the group; and
the velocity of the pedestrian being greater than a threshold difference from a velocity of the group.

17. The non-transitory machine-readable medium of claim 14, wherein the instruction that, when executed by the processor, causes the processor to produce the group restoration countermeasure comprises an instructions that, when executed by the processor, cause the processor to:
impair an operational capability of a user device of the pedestrian; and
restore the operational capability of the user device responsive to the pedestrian joining the group.

18. A method, comprising:
identifying, based on sensor data, a movement behavior of a pedestrian;
classifying the pedestrian as being isolated from a group of pedestrians based on the movement behavior of the pedestrian and a movement behavior of the group; and
producing a group restoration countermeasure responsive to the pedestrian being classified as isolated from the group, the group restoration countermeasure encourages the pedestrian to join the group.

19. The method of claim 18, wherein:
identifying the movement behavior of the pedestrian comprises identifying a location of the pedestrian; and
classifying the pedestrian as being isolated from the group of pedestrians comprises classifying the pedestrian as being isolated from the group when the location of the pedestrian is a threshold distance away from a location of the group.

20. The method of claim 18, wherein:
identifying the movement behavior of the pedestrian comprises identifying:
a direction of travel of the pedestrian; and
a velocity of the pedestrian; and
classifying the pedestrian as being isolated from the group of pedestrians comprises classifying the pedestrian as being isolated from the group based on:
the direction of travel of the pedestrian being within a threshold difference from a direction of travel of the group; and
the velocity of the pedestrian being greater than a threshold difference from a velocity of the group.
